(19) United States
(12) Patent Application Publication
(10) Pub. No.: US 2011/0175414 A1
(43) Pub. Date: Jul. 21, 2011

(54) CHAIR DEVICE

(76) Inventor: Svein Asbjornsen, Sykkylven (NO)

(21) Appl. No.: 12/936,097

(22) PCT Filed: Apr. 2, 2009
(86) PCT No.: PCT/NO09/00132

§ 371 Date: Mar. 25, 2011

(30) Foreign Application Priority Data
Apr. 2, 2008 (NO) 2008 1639

(51) Int. Cl. A47C 3/00; F16M 11/26; A47C 3/20; A47C 1/00

(52) U.S. Cl. 297/313; 248/371

(57) ABSTRACT

A chair device, wherein the chair has a base, an upright, length-adjustable supporting column which at the bottom is connected to the base, and a seat device which is tiltably or non-tiltably connected to an upper region of the supporting column. A lower, elastically resilient coupling forms a tiltable connection between the base and a lower portion of the supporting column. The lower coupling is designed to permit tilting of the supporting column relative to the base in any one of 360° of tilting direction or only in one tilting direction.

### BACKGROUND

The present invention relates to a chair device, wherein the chair has a base designed to rest against or be secured to a surface, e.g. a floor or deck, an upright, length-adjustable column which at a lower region thereof is connected to the base, a seat device that is tiltably or non-tiltably connected to an upper region of the column, and a lower elastically resilient coupling which forms a tiltable connection between the base and a lower portion of the supporting column. The invention further relates to equipment for a chair to permit a seat device of the chair arranged on a supporting column to the tiltable relative to a surface against which a base of the chair rests, the equipment being constituted of an elastically resilient coupling for mounting between the support column and the base, such that the supporting column is tiltable relative to the base.

### SUMMARY

Such technical solutions are found in countless versions, inter alia, as a chair or seating means for use in connection with drawing boards, dentist's seating means for use when treating a patient, or seating means for use when operating control panels on ships or trains. In some cases, the base is secured to the underlying surface, whilst in other cases it is movable relative to the underlying surface. In some embodiments the seat may be tiltable, for example, forwards in one direction relative to the supporting column, whilst in other embodiments the seat is fixedly secured to the supporting column, the base on its underside having a flat, central portion and a portion sloping thence towards the periphery, such that a certain tilting of the base relative to the underlying surface is possible.

Such a tilting of the base relative to the underlying surface has the advantage that for the chair user it is possible to reduce the distance between the seat and, for example, a drawing board, the chair user thereby at the same time obtaining a larger angle between his/her thighs and torso and thus improved breathing in his/her working position. In this case, the seat is, as a general rule, fixedly secured to the supporting column, and forward tilting of the supporting column will thus also cause the seat to tilt forwards. If backward tilting of the supporting column is attempted in order to increase the distance of the seat to, for example, a drawing board, the seat will also tilt backwards thereby putting the user at risk of falling backwards. In addition, such a tiltable base might easily cause a substantial point load on the underlying surface, for example, a wooden floor of pine, and might cause scratches or dents in a beautiful floor surface.

The patent literature describes related prior art, e.g. in NO 179476, U.S. Pat. No. 6,601,818, DE1205666, FR 1170615, U.S. Pat. No. 6,644,742 and GB 616243. Further prior art is found in e.g. NO 160406, U.S. Pat. No. 6,997,511, U.S. Pat. No. 2,609,033 and U.S. Pat. No. 1,610,069.

Recognising the drawbacks associated with such known chair constructions, where, for example, when working at a desk, drawing board or the like, it is desirable to be able to move the body forwards or backwards and/or sideways relative thereto, without any risk of falling off the chair during such a manoeuvre or without needing to move the chair base, it has been an object of the present invention to arrive at a technical solution that is simple, reliable and easy to operate.

According to the invention, the lower coupling of the chair comprises an outer tubular body, and inner tubular body, and an elastically resilient material disposed in a gap between an inner surface of the outer body and an outer surface of the inner body, a tilt shaft or two tilt shaft members extending through the resilient material and engaging the outer tubular body and the inner tubular body.

By this, it will be understood that the base either may be of a movable type, but such that the base need not be moved to make use of the manoeuvrability that is permitted, or that the base is fixedly mounted or fixedly mountable to a floor, a deck or the like.

Additional embodiments of the chair will be apparent from subsidiary claims 2-6, and from the following description with reference to the attached drawings.

According to the invention the elastically resilient coupling of the equipment comprises an outer tubular body and an elastically resilient material disposed in a gap between an inner surface of the outer body and an outer surface of the inner body, a tilt shaft or two tilt shaft members extending through the resilient material and engaging the outer tubular body and the inner tubular body.

Upon tilting of the supporting column relative to the base, it will be possible to cause the seat device to tilt correspondingly in the opposite direction relative to the supporting column, possibly such that the position of the seat in relation to a horizontal plane is essentially unchanged irrespective of the tilting direction and the tilting angle of the supporting column relative to the base. This presupposes that the seat device is tiltably connected to the supporting column.

Additional embodiments of the equipment can be seen from attached claims 8 and 9.

### BRIEF DESCRIPTION OF THE SEVERAL VIEWS OF THE DRAWINGS

FIG. 1 shows the device according to the invention being utilised by a person.

FIGS. 2a-2c show three of a plurality of possible positions of use of the device.

FIGS. 3a, 3b, 3c and 3d illustrate an upper, elastically resilient coupling for use with the device, shown respectively from below, from one side, from above and in section along IIId-IIId.

FIGS. 4a, 4b, 4c and 4d illustrate equipment for a chair, the equipment being in the form of an elastically resilient coupling for permitting tiltability of a supporting column of a chair relative to the chair base, and where the coupling is shown respectively from above, from one side, from below and in section along IVd-IVd.

FIGS. 5a, 5b, 5c, 5d, 5e and 5f illustrate an upper, elastically resilient coupling for use with the device, shown respectively from below, from above, in a side view and in section along Vd-Vd, Ve-Ve and Vf-Vf.

FIGS. 6a, 6b, and 6c illustrate the equipment in the form of an elastically resilient coupling for permitting tiltability of a supporting column of a chair relative to the chair base, and where the coupling is shown respectively from the side, in cross-section and in section along VIc-VIc.

FIGS. 7a, 7b and 7c illustrate a standard coupling, where indicated measurements will be the same whether it is an upper coupling or equipment in the form of a lower coupling, shown respectively from above, from the side and in cross-section VIIc-VIIc.

### DETAILED DESCRIPTION

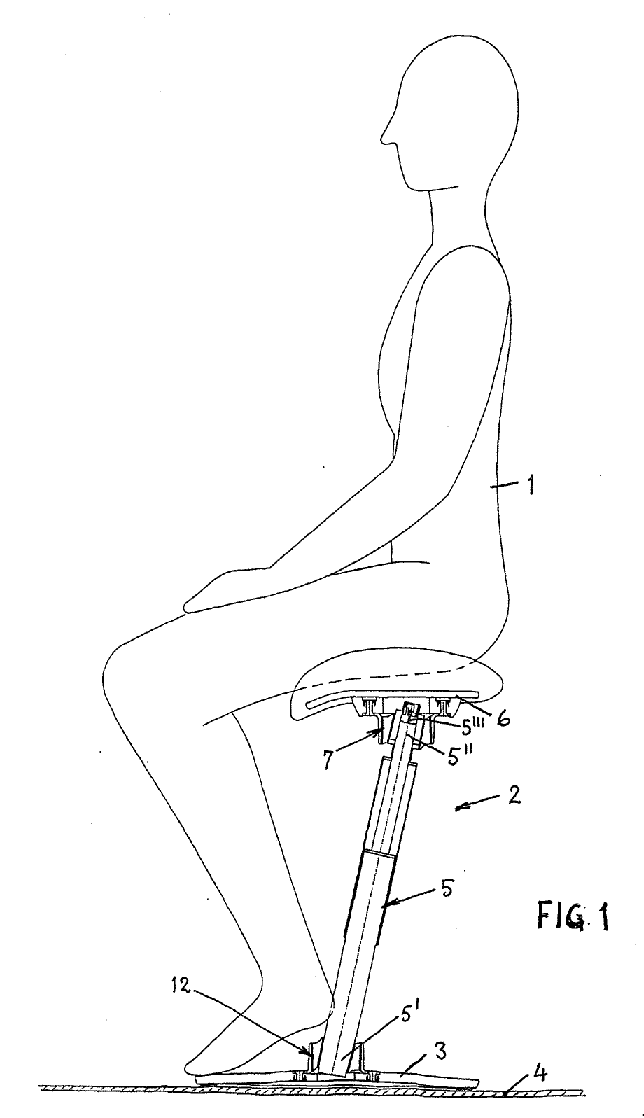

FIG. 1 shows a person 1 who has taken into use the inventive chair device 2 according to the invention. The chair has a base 3 designed to rest against an underlying surface 4, for example, a floor. An upright, length-adjustable supporting column 5 is, at a lower region 5′ thereof, connected to the base 3, and a seat device 6 is connected to an upper region 5″ of the supporting column 5.

An upper, elastically resilient coupling 7 forms a tiltable connection between the seat device 6 and the upper region 5″ of the supporting column 5, and equipment in the form of a lower, elastically resilient coupling 12 forms a tiltable connection between the base 3 and the lower region 5′ of the column 5. However, it is conceivable that the coupling between the seat device 6 and the supporting column 5 is not tiltable.

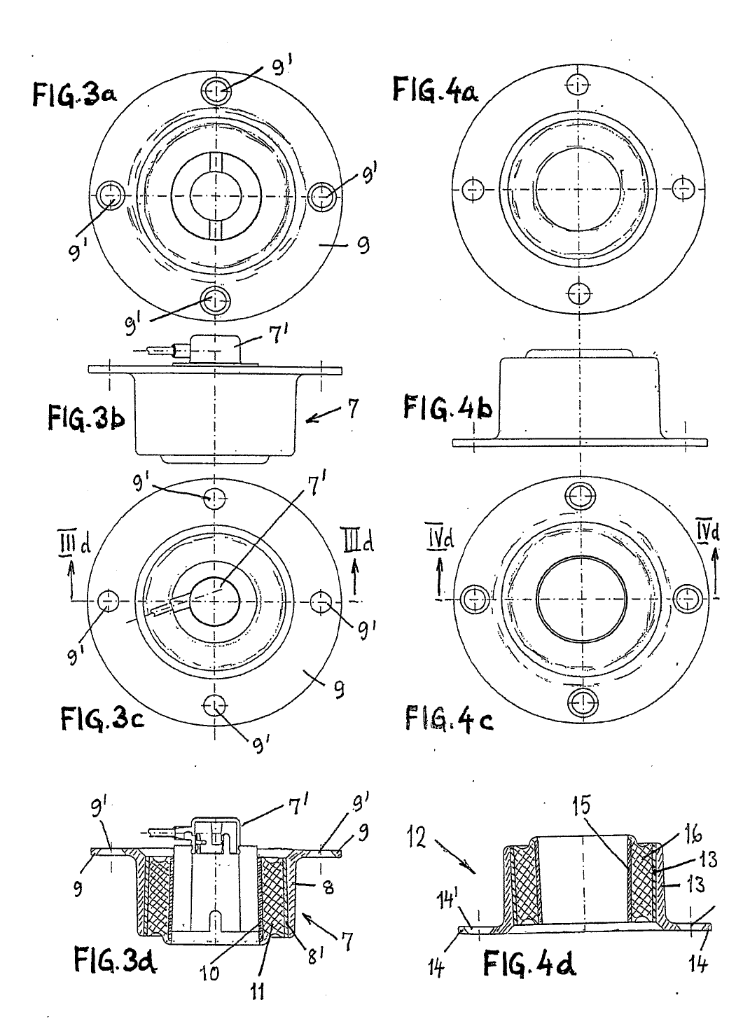

Although, within the scope of the invention, it could have been possible to make the supporting column length-adjustable by means of a nut and screw rod connection, it is, according to a preferred embodiment, regarded as expedient that the supporting column 5 is telescopically length-adjustable, i.e., that it may expediently be constituted of a gas spring which has a release 5′″ that projects outwards close to the top of the upper coupling. In this case, it will be advantageous to be able to equip the upper coupling 7 with a release adapter 7′ (see FIGS. 3b-3d) secured to its upper surface to facilitate manual actuation of the gas spring release 5″′ via a pull 7″, for example, a pull cord.

The upper coupling will now be described in more detail with reference to FIGS. 3a-3d. It consists of an outer tubular body 8 which, at the top, has a flange 9 with fastening holes 9′ for attachment to an underside of the seat device 6. Furthermore, there is an inner tubular body 10 at a radial distance from the inner surface of the outer tubular body 8. An elastically resilient material 11 is disposed in a gap between the inner surface of the outer tubular body 8 and the outer surface of the inner tubular body 10. The outer tubular body 8 has an inner surface that is tapered in the upward direction and has a correspondingly tapered lining 8′ along its inner surface, the lining 8′ connecting with the elastically resilient material 11. The inner tubular body 10 is correspondingly tapered in the upward direction and connects with the elastically resilient material 11. The elastically resilient material 11 is advantageously vulcanised on the lining 8′ and the inner body 10, respectively.

The lower coupling 12, which forms equipment for tiltability between the supporting column and the base, will now be described in more detail with reference to FIGS. 4a-4d. It consists of an outer tubular body 13 which has a flange 14 with fastening holes 14′ for attachment to the base 3.

It will be understood that attachment of the flange directly to a floor or a deck is to be regarded as a technical equivalent of the use of a loose base which can be placed on, for example, a floor or a deck, the floor or the deck in this case forming both the base and the underlying surface.

An inner tubular body 15 is arranged at a radial distance from the inner surface of the outer tubular body 13. Furthermore, an elastically resilient material 16 is disposed in a gap between the inner surface of the outer body 13 and the outer surface of the inner body 15. The outer tubular body 13 has an inner surface that is tapered in a downward direction and has a correspondingly tapered lining 13′ along its inner surface, the lining 13′ forming the actual connection with the elastically resilient material 16. The inner tubular body 15 is, as shown, correspondingly tapered in the downward direction and connects with the elastically resilient material 16. The elastically resilient material 16 is advantageously vulcanised on the lining 13′ and the inner body 15, respectively.

In that respectively the lower 5′ and the upper 5″ region of the supporting column 5 are made so as to taper towards the respective end thereof, a satisfactory wedge-fit engagement is obtained with respectively said lower coupling 12 and said upper coupling 7.

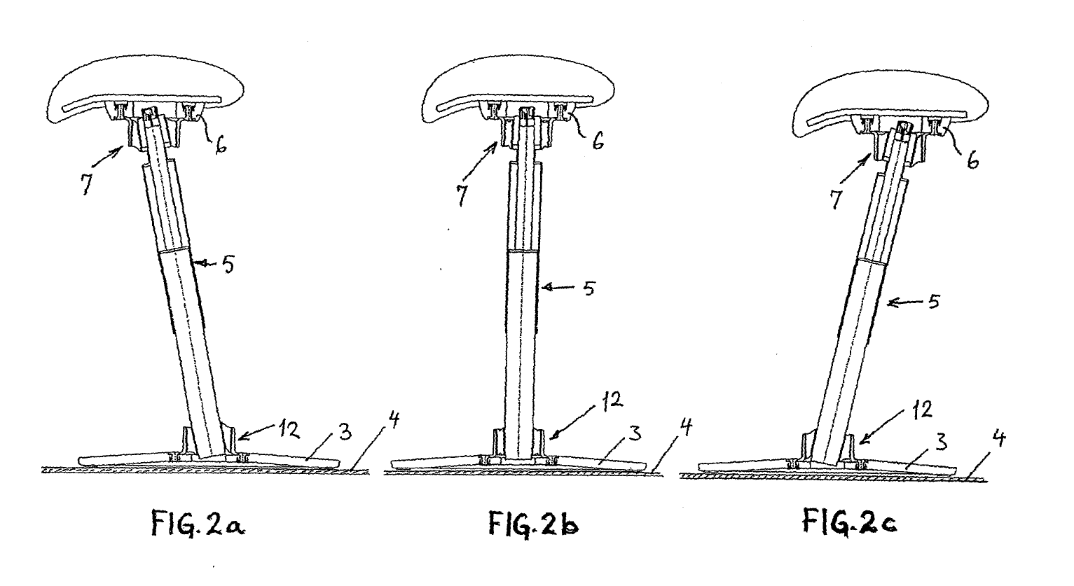

As will be seen from FIGS. 2a-2c, the upper coupling 7 is designed to permit tilting of the seat relative to the supporting column 5 in any one of 360° of tilting direction, and similarly said lower coupling 12 is designed to permit tilting of the supporting column 5 relative to the base in any one of 360° of tilting direction. This means that with the present device it is possible not only to tilt to and fro, but also to tilt sideways, optionally in a composite movement, for example, forwards and at the same time sideways, i.e., a diagonal movement forwards. It will thus be understood, especially when tilting to and fro in an essentially vertical plane, that on tilting the supporting column 5 relative to the base 3, the seat 6 is made to tilt correspondingly in the opposite direction relative to the column 5, such that the tilting position of the seat relative to a horizontal plane, for example, parallel to a floor or a deck, is essentially unchanged irrespective of the tilting direction and the tilting angle of the supporting column 5 relative to the base 3. However, it will also be understood that it is conceivable that the seat, for example, can be tilted slightly less or slightly more relative to the supporting column 5 than the angle the supporting column 5 tilts relative to the base 3. This may, for example, be dependent on the chair user, i.e., the person 1, in the new position finding it more comfortable to allow the seat 6 to have a slightly changed tilting position relative to the horizontal plane in relation to the tilting position of the seat prior to the change.

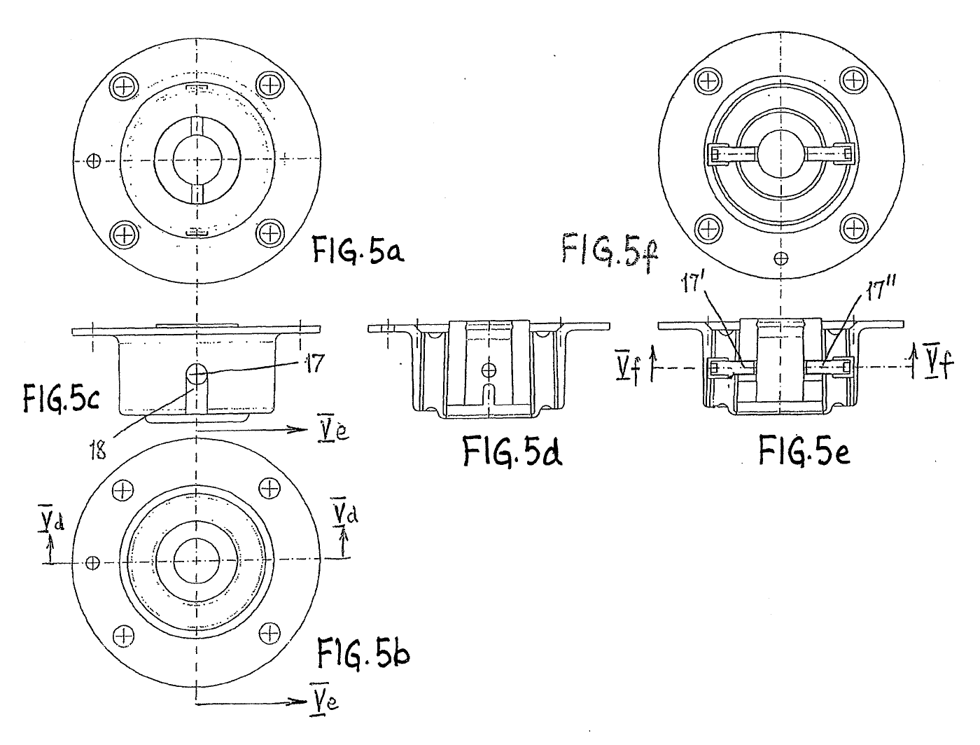

FIG. 5 indicates how in one embodiment it is conceivable to allow the seat to tilt only forwards and backwards, i.e., in reality about only one tilt axis. This is made possible by equipping the upper coupling with two tilt shaft members 17, 17′ which extend through the lining or the outer sleeve 8′ and through the inner tubular body or the sleeve 10. To facilitate the assembly of the shafts 17, 17′ together with the sleeves 8′ and 10, and the elastically resilient material 11 disposed therebetween, the outer body 8 is equipped with two guide grooves 18, 18′. This is an embodiment which may be especially useful in those cases where also the lower coupling is designed to be able to allow the column to tilt only forwards and backwards, i.e., in reality about only one tilt axis. The solution is also suitable for those cases where the choice is made to allow the lower coupling not to be tiltable.

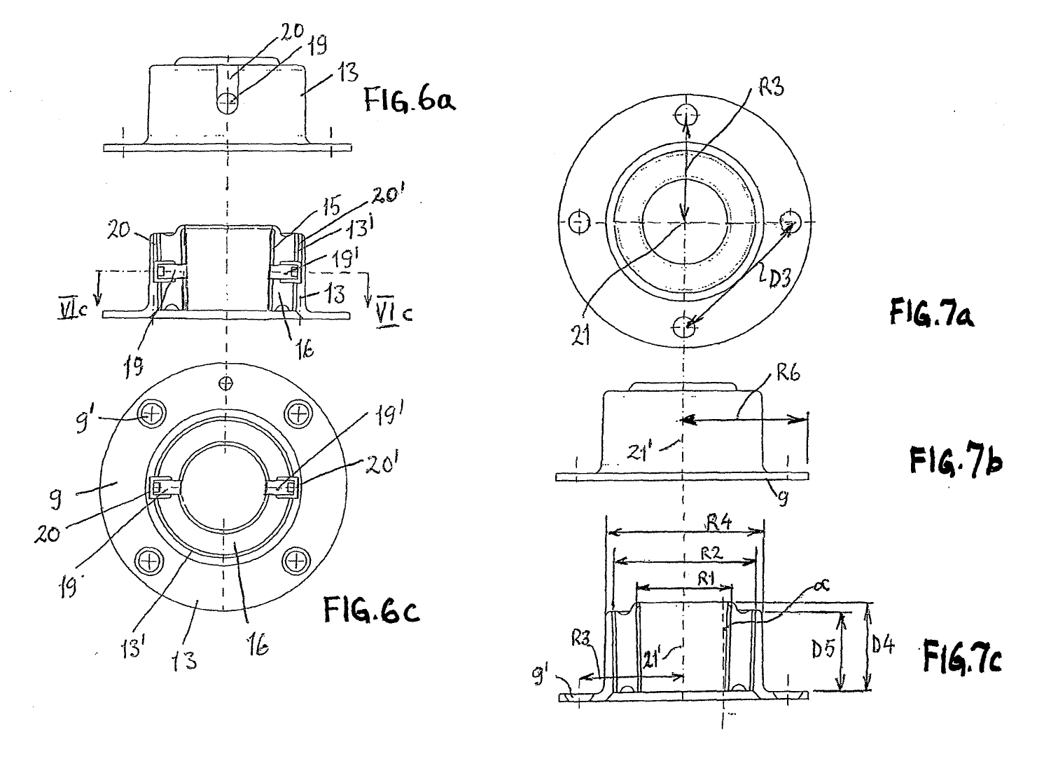

As mentioned above it is also conceivable that only the lower coupling is tiltable, optionally that in such a case it is adapted to allow the supporting column to tilt only forwards and backwards in one tilt plane relative to the base. For the said possible case, it is shown in FIG. 7 how this can be done by equipping the lower coupling with two tilt shaft members 19; 19′ which extend through the lining or the outer sleeve 13′ and through the inner tubular body or the sleeve 15. To facilitate the assembly of the shaft members 19, 19′ together with the sleeves 13′, 15, and the elastically resilient material 11 disposed therebetween, and then to insert the assembled parts into the outer body 13, the outer body 13 is equipped with guide grooves 20, 20′. This design may also be relevant in the cases where the upper coupling is designed to be able to allow the seat device to tilt only forwards and backwards, i.e., in reality about only one tilt axis, for example, so that both the tilt axis of the seat device relative to the supporting column and the tilt axis of the supporting column relative to the base are parallel.

According to a currently preferred embodiment, both the upper and the lower coupling are so designed that they have the following parameters, measured at the widest region of the coupling:

outer radius of inner tubular body 10;15 is R1=27 mm±2 mm;

thickness of the inner tubular body 10; 15 is D1=2 mm±0.5 mm;

outer radius of outer lining 8′; 13′ is R2=41 mm±2 mm;

thickness of outer lining 8′; 13′ is D2=2 mm±0.5 mm;

thickness of elastically resilient material 11; 16 is R2−D2−R1=12 mm±4.5 mm;

centre distance of fastening holes 9′ from the radial centre 21 of the coupling is R3=59 mm±2 mm;

distance between centres of fastening holes is D3=84 mm±2 mm;

axial length of inner tubular body is D4=48 mm±2 mm;

axial length of lining is D5=45 mm±2 mm;

outer radius of outer tubular body or holder 8; 13 is R4=44 mm±2 mm;

outer radius of flange on the holder 8; 13 is R6=70 mm±2 mm; and

angle of conicity a relative to the axial centre line 21′ parallel thereto (standard for gas springs) is 1.44°.

The inner cavity, i.e., that formed by the sleeve 10; 15 will be adapted to the cross-section and conicity of a standard gas spring, but if gas springs with a different cross-section and/or conicity are used, it is then possible to make use of an adapter to ensure a good fit.

1.-9. (canceled)

10. A chair which has:
a base designed to rest against or be secured to a surface,
an upright, length-adjustable supporting column which at the bottom is connected to the base;
a seat device that is tiltably or non-tiltably connected to an upper region of the supporting column, and
that a lower elastically resilient coupling which forms a tiltable connection between the base and a lower portion of the supporting column,
characterised in
that the lower coupling comprises an outer tubular body, an inner tubular body, and an elastically resilient material disposed in a gap between an inner surface of the outer body and an outer surface of the inner body,
a tilt shaft or two tilt shaft members extending through the resilient material and engaging the outer tubular body and the inner tubular body.

11. A chair as disclosed in claim 10 when the seat device is tiltably connected to the supporting column, characterised in that when the supporting column is tilted relative to the base, the seat device is caused to tilt correspondingly in the opposite direction relative to the supporting column.

12. A chair as disclosed in claim 11, characterised in that the position of the seat relative to a horizontal plane is essentially unchanged irrespective of the tilting direction and the tilting angle of the supporting column relative to the base.

13. A chair as disclosed in claim 10, characterised in that the outer tubular body has flanges for attachment to the base; and that the inner tubular body is at a radial distance from the inner surface of the outer body.

14. A chair as disclosed in claim 13 when the seat device is tiltably connected to the supporting column, characterised in that when the supporting column is tilted relative to the base, the seat device is caused to tilt correspondingly in the opposite direction relative to the supporting column.

15. A chair as disclosed in claim 14, characterised in that the position of the seat relative to a horizontal plane is essentially unchanged irrespective of the tilting direction and the tilting angle of the supporting column relative to the base.

16. A chair as disclosed in claim 10, characterised in that the outer tubular body has on an inner wall face thereof a lining which connects to said resilient material, said tilt shaft or tilt shaft members extending through the lining.

17. A chair as disclosed in claim 16 when the seat device is tiltably connected to the supporting column, characterised in that when the supporting column is tilted relative to the base, the seat device is caused to tilt correspondingly in the opposite direction relative to the supporting column.

18. A chair as disclosed in claim 17, characterised in that the position of the seat relative to a horizontal plane is essentially unchanged irrespective of the tilting direction and the tilting angle of the supporting column relative to the base.

19. A chair as disclosed in claim 16, characterised in
that the outer tubular body has an inner surface that is tapered in a downward direction and with the lining correspondingly tapered, and
that the inner tubular body is correspondingly tapered in the downward direction and with its outer face connects with the elastically resilient material.

20. A chair as disclosed in claim 19 when the seat device is tiltably connected to the supporting column, characterised in that when the supporting column is tilted relative to the base, the seat device is caused to tilt correspondingly in the opposite direction relative to the supporting column.

21. A chair as disclosed in claim 20, characterised in that the position of the seat relative to a horizontal plane is essentially unchanged irrespective of the tilting direction and the tilting angle of the supporting column relative to the base.

22. Equipment for a chair to permit a seat device of the chair arranged on a supporting column to be tiltable relative to a surface against which a base of the chair rests, the equipment being constituted of an elastically resilient coupling for mounting between the supporting column and the base, such that the supporting column is tiltable relative to the base, characterised in that the elastically resilient coupling comprises an outer tubular body, an inner tubular body and an elastically resilient material disposed in a gap between an inner surface of the outer body and an outer surface of the inner body, a tilt shaft or two tilt shaft members extending through the resilient material and engaging the outer tubular body and the inner tubular body.

23. Equipment as disclosed in claim 22, characterised in that the outer tubular body has at one axial end a flange for attachment to the base; and that the inner tubular body is at a radial distance from the inner surface of the outer body for attachment to the lower portion of the supporting column.

24. Equipment as disclosed in claim 23, characterised in that the outer tubular body has an inner surface that is tapered in the axial direction towards the flange and has a correspondingly tapered lining along its inner surface, the lining connecting with the elastically resilient material; said tilt shaft or tilt shaft members extending through the lining; and that the inner tubular body is correspondingly tapered in a downward direction of the flange and with its outer face connects with the elastically resilient material.
